(19) United States
(12) Patent Application Publication
(10) Pub. No.: US 2003/0021877 A1
(43) Pub. Date: Jan. 30, 2003

(54) Micronised fat particles

(76) Inventors: Frederick William Cain, Wormerveer (NL); Tony Herzing, Channahon, IL (US); Gerald Patrick McNeill, Channahon, IL (US)

Correspondence Address: MORGAN LEWIS & BOCKIUS LLP, 1111 PENNSYLVANIA AVENUE NW, WASHINGTON, DC, 20004, US

(21) Appl. No.: 09/879,863

(22) Filed: Jun. 13, 2001

(51) Int. Cl. A23D 7/00

(52) U.S. Cl. 426/601

(57) ABSTRACT

The invention concerns with micronized fat continuous particles comprising fat and non fat ingredients, wherein the particles have a mean weight diameter (MWD) of 700 to 4000 microns, while the particles have a particle size distribution so that more than 75 wt % of the particles have a particle size that is inside the range (MWD+0.4×MWD) to (MWD−0.4×MWD); food products comprising a fat phase, wherein these particles are present, a process to prepare these micronized fat particles and the use of these particles in food products to achieve benefits, such as bio availability, stability, oral melt, hardness, texture, homogeneity and ease of dosing.

Micronised fat continuous particles, comprising fat and non-fat ingredients are well known in the art and are even applied on a commercial scale. The micronised fat particles known so far however have a broad particle size distribution. We found that such particles had a number of drawbacks when applied in food products such as baked bakery products (the baking process is negatively affected by the presence of fines in the particles, while the presence of too high amounts of the bigger particles can have a negative impact on the performance of the yeast required in many bakery products). Further are the colour and flavour of ice creams negatively affected by the presence of fines in the particles whereas in confectionery products like truffle fillings and toffees the presence of too much of the bigger particles deteriorate the taste performance of the products.

We studied whether we would could overcome the problems indicated above and we found as a result hereof that the use of particles with a specific particle size distribution could solve these problems. Therefore our invention concerns in the first instance micronised fat continuous particles comprising fat and non fat ingredients, wherein the particles have a mean weight diameter (MWD) of 700 to 4000 microns, while the particles have a particle size distribution so that more than 75 wt % of the particles have a particle size that is inside the range (MWD+0.4×MWD) to (MWD−0.4×MWD). The MWD is defined as set out in the examples wherein also the method to measure the MWD is given. Preferably particles are applied wherein MWD is 1000 to 3500 microns, most preferably 1500 to 3000 microns. The best results were obtained when using particles having a size distribution so that more than 75 wt % is inside the range (MDW+0.3×MDW) to (MDW−0.3×MDW).

The micronised particles contain fat ingredients and non-fat ingredients preferably in such amounts that the particles comprise 10 to 90 wt % of non fat ingredients, preferably 20 to 80 wt %, more preferably 25 to 60 wt %. These non-fat ingredients are preferably selected from the group consisting of sugars, carbohydrates, starches, modified starches and flavouring compounds and thus are preferably nutritionally active ingredients.

Although a wide range of fats can be applied we found that the best results were obtained if the fats display a melting point between −5° C. and 75° C., preferably between 10 and 50° C., most preferably between 15 and 45° C. Preferred fats meeting these requirements can be selected from the group consisting of: sunflower oil, palm oil, rape oil, cotton seed oil, soy bean oil, maize oil, shea oil, cocoa butter or fractions thereof or in a hardened form or as fraction of the hardened oil or as partially hydrolysed oil rich in diglycerides or as mixtures thereof. Very benefical is also the use of nutrionally active fats, preferably selected from a CLA-glyceride or a fat that comprises PUFA fatty acid in high amounts such as fish oil, fish oil concentrates, fungal oils, as the use of these fats will add the nutritional benefits of these fats to the micronised particles and thus to the end product.

Flavours that can be applied are in principle all known flavours but we prefer to apply flavours selected from the group consisting of butter flavour, cinnamon flavour, fruit flavour, cheese flavour.

Very suitable micronised particles are obtained by producing particles with a water content of less than 2 wt %.

The micronised particles are very effective for use in food products as alternative for the known fat flakes, known as betrflakes ^{R} which are commercially on the market. (product from Loders Croklaan).

The micronised particles, can be used for the preparation of food products with a fat phase wherein more than 30 wt % of the micronised particles is present. Typical food products are food products selected from the group consisting of ice cream, baked goods, coatings, fillings, toppings, soups, sauces, dry mixes, spreads.

The micronised particles according to the invention can be made by a process comprising the following steps:

a fat melt is made

non fat ingredients are slurried in the molten fat

the slurry is cooled, preferably on a flaking drum cooler

flakes of a fat continuous slurry are collected from the drum flaker

which flakes optionally are reduced in size, preferably by a breaker bar system

whereupon either the flakes or the size reduced flakes are subjected to a cryomilling by cooling them with a cryocoolant, such as liquid nitrogen or solid carbon dioxide and reducing them in size while cold, in particular while having a temperature of −85 to 10° C.

In above process we prefer to perform a milling in a cryomiller to a particle size of more than 20 microns and in particular to particles with a size as required for the products according to the invention.

The flakes can also be obtained by using other cooling equipment, such as a cooling belt. The fat melt can be subjected to an initial cooling using equipment such as a Sandvik Belt® or a confectionery cooling tunnel.

According to a last embodiment of our invention the invention concerns also the use of the micronised particles according to the invention to achieve a number of benefits in food products i.e.:

improve the bioavailability of the nutrional ingredients present in the particles and/or

to improve the stability of the nutrional ingredients present in the food products and/or

to improve oral melt, hardness or texture of food products and/or

to improve the homogeneity of the active ingredient in the food products and/or

to improve the ease of dosing of minor components in food products.

### EXAMPLES

Process

1.1 Method

Process Flakes—Standard Procedure.

The ingredients used for the flake procedure were:

Icing sugar

Fat blend

Sanding sugar

Unbleached pastry flour

Powdered Lecithin

Colour and flavour system, depending on the type

1. The process began by producing slurry of fat and powders and/or liquid or dry flavours. This was mixed in a vacuum rated vessel.

2. After mixing the slurry was pumped to a flake roll which was cooled to a temperature between −18 and 38° C., depending on the melting point of the fat

3. The fat and dry particulate slurry was applied to the outside of the roll and was cooled to the point of solidification and scraped off using a knife blade.

4. The chilled slurry, now in the form of large flakes or sheets felt into a hopper where it was broken into conveyable sized pieces by a breaker bar system.

5. Flakes were ready to subject to a cryo-milling process, like described next.

Process Fractions—Standard Procedure.

The starting material was either standard BetrFlakes (10×10 ×4 millimeters) or mini BetrFlakes (10×4×3 millimeters). The flakes were cooled to less than 0° C. by adding solid carbon ioxide. The Quadro Comil model no. 197GPS® was set on a speed setting using a specific grater screen. The flakes were added into the Quadro Comil by hand and the ground material (unsieved material) was collected. The ground unsieved material was separated into three fractions using a Sweco Separator (Vibro Energy® 1200 rpm) model no. 1S30S444. Three fractions were collected:

fraction A, those retained on a US#8 (2360 microns)

fraction B, those who went through a US#8 (2360 microns) and retained on a US#16 (1180 microns)

fraction C, those who went through a US#16 (500 microns)

The weight of each fraction was measured and expressed as the weight percent of the total material used.

In each fraction as well as in the unsieved material the particle size distribution was determined using a Ro-Tap Testing Sieve Shaker® model no. B. A known weight of the sample was shaken for 5 minutes in the Ro-Tap. The weight of material retained by each sieve was measured and expressed as a weight percent of the total material used. The screen sizes, used in a Ro-Tap Testing Sieve Shaker® (model no. B), are described in table 1.1.

TABLE 1.1
The US screens of the Ro-Tap Testing Sieve Shaker in microns

| | | Average |
|---|---|---|
| Screen size | Diameter | Diameter |
| (mesh) | (microns) | (microns) |
| On US #4 | 4750 microns | 4750 |
| On US #6 | 3350 microns | 4050 |
| On US #8 | 2360 microns | 2855 |
| On US #10 | 2000 microns | 2180 |
| On US #12 | 1700 microns | 1850 |
| On US #14 | 1400 microns | 1550 |
| On US #16 | 1180 microns | 1290 |
| On US #18 | 1000 microns | 1090 |
| On US #20 | 850 microns | 925 |
| Through US #20 | 500 microns | 675 |
| On US #30 | 600 microns | 725 |
| On US #40 | 425 microns | 512.5 |
| On US #50 | 300 microns | 362.5 |
| Through US #50 | 250 microns | 275 |

For each fraction the mean weight diameter in microns was determined.

The average diameter of the material passing screen size “y” and retained by screen size “x” equals:

[(Diameter of screen “x”)+(Diameter of screen “y”)]/2

Whereas “y”=the next widest screen size than “x” which was used in the Ro-Tap.

The average diameters of the screens used in the Ro-Tap during the experiment are described in table 1.1.

The particle size distribution was determined as:

Weight percent of material with each of these average diameters

The mean weight diameter was calculated using the following formula:

1. For each diameter in a fraction weight diameter was calculated:

[(Average diameter)×(weight fraction of that average diameter)]

2. Mean weight diameter:

All weight diameters of the fraction summed

To clarify this a calculation will be given for the data from table 1.2.

TABLE 1.2
Particle size distribution of example fraction x

| | Average | |
|---|---|---|
| Diameter | Diameter | |
| (microns) | (microns) | Fraction |
| 4750 | | 0 |
| 3350 | 4050 | 0.072 |
| 2360 | 2855 | 0.7 |
| 2000 | 2180 | 0.213 |
| 1700 | 1850 | 0.01 |
| 1400 | 1550 | 0.002 |

1.2 Determination of Particle Size Distribution and Mean Weight Diameter

In this paragraph the particle size distribution and the mean weight diameter will be described for different products In the different patent examples a reference will be made to these data.

Experiments

Experiment 1

Following standard procedure as described in Method 1.1.

Used products and settings;

| | |
|---|---|
| Flakes: | Mini Raspberry BetrFlakes |
| Speed Comil: | 17650 rpm |
| Screen size Comil: | 156 G |

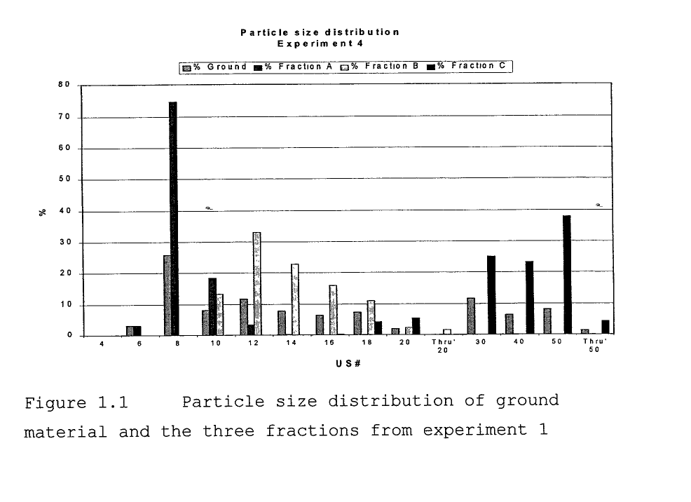

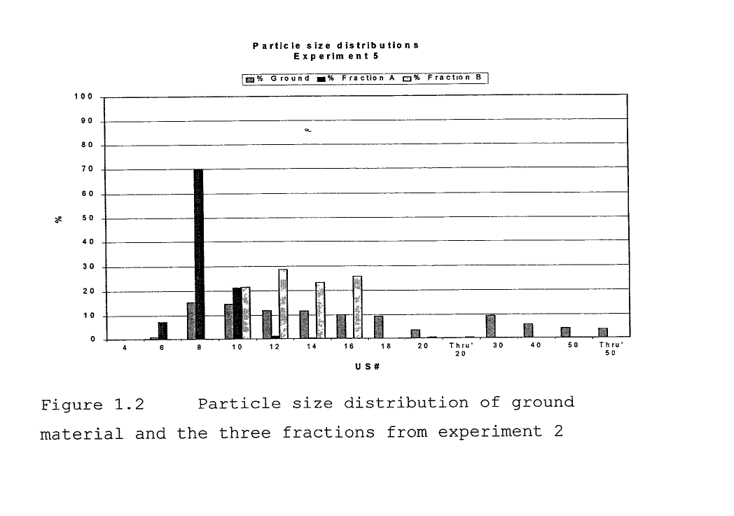

The weight percentage of fractions recovered from the ground material is described in table 1.3. The particle size distribution of the ground material and the particle size distribution of each fraction can be found in FIG. 1.1 and in the appendix tables 1.10 until 1.14.

| Fraction | Weight |
|---|---|
| recovered from | Percentage |
| ground material | (%) |
| Fraction A | 31.55 |
| Fraction B | 36.71 |
| Fraction C | 31.75 |

Table 1.3 The weight percentage of fractions recovered from ground material from experiment 1 (cf FIG. 1.1)

Experiment 2

Following Laboratory Flake make-up Procedure and Ice Cream Fraction Comil Procedure, like described below;

Used products and settings;

| | |
|---|---|
| Flakes: | Raspberry Paramount B flakes |
| Speed Comil: | 1200 rpm |
| Screen size Comil: | 156 G |

Laboratory Flake Make-Up Procedure

The recipe for these flakes is given in table 1.4.

1. Dry ingredients (icing sugar 6X, sanding sugar, 28 DE maltodextrin, malic acid, tricalcium phosphate, sodium citrate dihydrate, raspberry powder, red lake, blue lake, and lecithin) were combined in a small Hobart (model no. C-100) bowl. Water jacket was set at 41-43° C.

2. Mixed for approximately ten minutes on (speed 1).

3. The Paramount B was melted and added to the dry ingredients in Hobart. Mixed for approximately fifteen minutes on (speed 1) maintaining water jacket temperature of 41-43° C.

4. Artificial raspberry flavour was added to mixture and mixed for five minutes.

5. The molten mass was spread on a pre-chilled baking sheet with parchment liner.

6. Returned sheet to freezer (−22° C.) for approximately twenty minutes.

7. Removed sheet and allowed standing at room temperature for fifteen minutes.

8. Cut into small rectangular pieces.

Ice Cream Fraction Comil Procedure

1. The Quadro Comil (model no. 197GPS) was set at zero speed on the speed dial (1200 rpm) with 0.156 size grater.

2. One thousand-gram batch of small rectangular pieces was milled through mill and the material was collected.

3. Five hundred grams of unsieved material was taken and a particle size distribution on a Ro-Tap Testing Sieve Shaker model no. B was run. The other five hundred grams was hand sieved on size # 8 and # 16 screens. Subsequent particle size distribution was performed on these two sizes on a Ro-Tap Testing Sieve Shaker model no. B.

TABLE 1.4
Recipe Paramount B Raspberry Flakes for ice
cream application

| Ingredients | % |
|---|---|
| Paramount B | 30 |
| Icing Sugar 6X | 30.13 |
| Sanding sugar | 16 |
| 28 DE Maltodextrin 178176 | 17 |
| Malic Acid | 1.5 |
| Tricalcium Phosphate | 0.4 |
| Sodium citrate, dihydrate | 0.3 |
| Rasp Art. F95133 Mane | 1.5 |
| DD −40 Raspberry PDR VD | 3 |
| FD & C RED #40 09310 | 0.1 |
| FD & C Blue #2 09901 | 0.01 |
| Lecithin, liquid | 0.06 |

The weight percentage of fractions recovered from the ground material is described in table 1.5. The particle size distribution of the ground material and the particle size distribution of each fraction can be found in FIG. 1.2 and in the appendix tables 1.15 until 1.18.

TABLE 1.5
The weight percentage of fractions recovered
from ground material from experiment 2

| Fraction | Weight |
|---|---|
| recovered from | Percentage |
| ground material | (%) |
| Fraction A | 34.6 |
| Fraction B | 40.5 |
| Fraction C | 12.3 |

Experiment 3

3.1 Bread Application

3.1.1 Ingredients

The used ingredients in this experiment were:

Bread Flour

Granulated Sugar

Salt

Non Fat Dry Milk Powder

Betrkake Shortening

Dry Yeast, Red Star Active Dry

Water

Raspberry fraction A from experiment 1 (on US #8,PSD >than 2,360 microns)

Raspberry fraction B from experiment 1 (on US #16,PSD less than 2,360 microns and greater than 1,180 microns

Raspberry ground, unsieved material from experiment 1 (Particle size distribution from 4,750 microns to 500 microns)

3.1.2 Method

Standard white bread dough was prepared using the following formula:

TABLE 1.6
Recipe Bread Dough application

| Ingredients | Percentage (%) |
|---|---|
| Bread Flour | 54.0 |
| Granulated Sugar | 1.8 |
| Salt | 0.8 |
| Non Fat Dry Milk Powder | 1.8 |
| Betrkake Shortening | 1.8 |
| Dry Yeast, Red Star Active | 0.8 |
| Dry | |
| Water at 43° C. | 39.0 |
| Total | 100% |

The Bread dough was prepared using a standard dough making procedure.

Procedure:

1. Flour, Granulated Sugar, Salt and Non-Fat Dry Milk and dry yeast were scaled into mixing Bowl and mixed until homogeneous (first speed Hobart mixer with Dough hook).

Betrkake Shortening was added and gradually water was added until dough was formed.

Mixed on medium speed (speed #2) for 3-speed mixer for 10 to 12 minutes until gluten was fully developed.

Following preparation of the Bread dough a measured portion of the dough was taken. To that portion the following material were added to each portion:

Portion 1

Added 10% by weight Raspberry fraction A from experiment 1 to Bread dough prepared as above. Fraction was incorporated by mixing Hobart mixer with dough hook, 5 minutes.

Portion 2

Added 10% by weight Raspberry fraction B from experiment 1 to Bread dough prepared as above. Fraction B was incorporated by mixing Hobart mixer with dough hook, 5 minutes.

Portion 3

Added 10% by weight ground, unsieved Raspberry material from experiment 1. The non-fractionated material was incorporated by mixing Hobart mixer with dough hook, 5 minutes.

Proofing and Baking

Following incorporation of the Fractions the doughs prepared from portion 1,2 and 3 were placed in a bowl and proofed for 1 hour. Dough was punched down, molded into loaves and proofed for another 20-30 minutes. Loaves were removed and baked at 204° C. for 25-30 minutes.

6. Baked loafs were cooled, weighed and measured for volume.

3.1.3 Evaluation method Bread Scoring

The bread volume was measured by Rapeseed displacement method. A loaf was placed in a container of known volume into which small seeds e.g. rapeseed were run until the container was full. The volume of the seeds displaced by the loaf was measured. Loaf volume per weight was then calculated.

3.1.4 Results and Conclusion

Raspberry Bread loaf Portion 3 using non-fractionated material the bread volume when measured was found to be 19.45% less than the bread prepared with fractionated material Portion 1. Raspberry Bread loaf Portion 3 using non-fractionated material the bread volume when measured was found to be 9.1% less than the bread prepared with fractionated material Portion 2.

From this data it can be concluded that using Raspberry fractions resulted in a larger bread volume than using ground, unsieved material. Within the bakery market it is well recognized that bread with a larger bread volume results in a more desirable texture than obtained with low bread volume. Using the unsieved Raspberry material the common baking procedure led to a poor bread volume, however using fraction A or fraction B of the Raspberry material larger, desirable bread volumes were obtained.

Experiment 4

Part 4.1 Ice Cream Application

4.1.1 Ingredients

The ingredients used in this experiment were:

Artificially flavoured vanilla ice cream (Nancy Martin)

Raspberry; fraction A from experiment 2 (on US #8,PSD>than 2,360 microns)

Raspberry; ground, unsieved material from experiment 2 (Particle size distribution from 4,750 microns to 500 microns)

4.1.2 Method

Procedure:

1. 10% by weight ground, unsieved Raspberry material from experiment 2 were put in artificially flavoured vanilla ice cream. As well 10% by weight Raspberry fraction A from experiment 2 were put in artificially flavoured vanilla ice cream.

2. The samples were put in cups and were coded R for the unsieved ground ice cream application and F for the ice cream application with fraction A.

3. A sensory panel evaluated the samples. A panel was run to determine significant differences in the areas of:

Visual identity between ice cream and inclusion

Textural differences

Flavour burst and balances between ice cream and inclusion

4.1.3 Sensory Evaluation Method

Each evaluation was carried out by the same Sensory panel, which consists of 12 persons. The evaluation panels were conducted under the same conditions and the same procedures. The panelists evaluated the products against each other with one of them as a reference for different described attributes. The sensory score sheet included a line scale for each attribute. The range from the scale went from −3 until +3, wherein the reference is zero on the line scale.

+/−3.0=big difference

+/−2.5=very clear difference

+/−2.0=clear difference

+/−1.5=very noticeable difference

+/−1.0=noticeable difference

+/−0.5=slight difference

0=same as reference

The following attributes were evaluated by the sensory panel for the ice cream application:

| | Negative | 0 | Positive |
|---|---|---|---|
| Appearance of particles | fewer | 0 | more |
| Bleeding of the inclusions | less | 0 | more |
| Meltdown | slower | 0 | quicker |
| Waxiness | less | 0 | more |
| Chewiness | less | 0 | more |
| Flavour release time | slower | 0 | quicker |
| Flavour retention | shorter | 0 | longer |
| Flavour impact | less | 0 | more |
| Aftertaste | shorter | 0 | longer |
| Sourness | less | 0 | more |

4.1.4 Results and Conclusions

In table 1.7 the results of the sensory evaluation for the ice cream application can be found. Only the results for sample F (fraction A) are described, since sample R was the reference and was zero on the line scale. The data only shows the attribute results from the differences between the two samples. The other data is left out.

TABLE 1.7
Results of the sensory evaluation of ice cream
application with fraction A (sample F) regarding to the
reference (sample R)

| | | | Number of | Number of |
|---|---|---|---|---|
| | Result | Average | panelists with | panelists |
| Ice cream | of | of the | positive or | with specific |
| attribute | panel | panel | negative | difference |
| Bleeding of | less | −1.5 | 10/12 = | 7/12 = −1.5, |
| inclusions | | | less bleeding | very |
| | | | of the | noticeable |
| | | | inclusion | difference |
| Meltdown | slower | −1.2 | 9/12 = slower | 7/12 = −1.5, |
| | | | meltdown | very |
| | | | | noticeable |
| | | | | difference |
| Waxiness | more | 0.9 | 7/12 = more | 7/12 = +2.0, |
| | | | waxy | clear |
| | | | | difference |
| Chewiness | more | 1.1 | 10/12 = more | 6/12 = +2.0, |
| | | | chewy | clear |
| | | | | difference |
| Flavor | slower | −0.8 | 10/12 = slower | 4/12 = −1.5, |
| release | | | flavour | very |
| time | | | release time | noticeable |
| | | | | difference |

Table 1.7 shows that using fraction A resulted in a visual sensation of the inclusion, namely less bleeding compared to the unsieved Raspberry material. Using fraction A resulted as well in a more waxy and chewier inclusion sensation. A very noticeable difference in flavour release of the inclusion can be found when using Raspberry fraction A.

It can be concluded from these results, that the ice cream keeps looking like a white ice cream and the inclusions were distinctive from the ice cream, when using fraction A, since there was less bleeding. The ground unsieved material had more bleeding and therefore showed less visual identity between the white ice cream and the pink inclusion.

Secondly it can be concluded that using fraction A, there was a more oral sensation of the inclusions. The inclusions appeared to be more waxy and more chewy, so textural more identifiable as a distinctive inclusion. The unsieved material gave a less textural sensation; therefore it was more difficult to identify the inclusion being a distinctive inclusion.

Finally it appeared that there is clear flavour identification from both the ice cream and the inclusion when using fraction A of the Raspberry material. It showed namely a delayed flavour release from the inclusion. Using the unsieved Raspberry material as the inclusion, there was no distinctive flavour between substrate and inclusion, since there was less flavour release delay, so both flavours appeared at the same time.

Overall it can be concluded that using fraction A of the Raspberry material in an ice cream application has given an identifiable white ice cream with distinctive inclusions both visual and oral, where the unsieved Raspberry material did not.

Experiment 5

5.1 Truffle

5.1.1 Ingredients

The following ingredients were used in this experiment:

Heavy whipping cream

42DE Corn syrup

Finely chopped white chocolate (Nestle)

Raspberry fraction B from experiment 1 (on US #16,PSD less than 2,360 microns and greater than 1,180 microns)

Raspberry ground, unsieved material from experiment 1 (Particle size distribution from 4,750 microns to 500 microns)

5.1.2 Method

Standard white truffle filling was prepared using the formula like described in table 1.8.

TABLE 1.8
Recipe of truffle application

| | Percentage |
|---|---|
| Ingredient | (%) |
| Cream | 31 |
| 42 DE corn syrup | 4 |
| White chocolate | 50 |
| Raspberry | 15 |
| fraction | |
| Total | 100 |

The standard white truffle filling was prepared using a standard white truffle filling making procedure.

Procedure:

1. Weighed the cream and the corn syrup directly into a pan.

2. Weighed out the chocolate in a bowl and then chopped into fine pieces using a cutting board.

3. The raspberry fraction was weighed into a large stainless steel bowl.

4. The cream and the corn syrup were boiled.

5. Poured the cream into the chocolate. The mixture was gently stirred until chocolate was melted.

6. Fraction B Raspberry from experiment 1 was added to the chocolate mixture. Sit was stirred gently.

7. Sample cups were filled and coded F.

The same procedure and formula were used for the 2^{nd} run, however using Raspberry ground unsieved material from experiment 1. These samples were coded R for the sensory panel. A sensory panel evaluated the samples. A panel was run to determine significant differences in the areas of:

Visual identity between white truffle filling and inclusion

Textural differences

Flavour burst and balances between truffle filling and inclusion

5.1.3 Sensory evaluation Method

Each evaluation was carried out by the same Sensory panel, which consists of 12 persons. The evaluation panels were conducted under the same conditions and the same procedures. The panelists evaluated the products against each other with one of them as a reference for different described attributes. The sensory score sheet included a line scale for each attribute. The range from the scale went from −3 until +3, wherein the reference is zero on the line scale.

+/−3.0=big difference

+/−2.5=very clear difference

+/−2.0=clear difference

+/−1.5=very noticeable difference

+/−1.0=noticeable difference

+/−0.5=slight difference

0=same as reference

The following attributes were evaluated by the sensory panel for the truffle application:

| | Negative | 0 | Positive |
|---|---|---|---|
| Appearance of particles | fewer | 0 | more |
| Bleeding of the inclusions | less | 0 | more |
| Meltdown | slower | 0 | quicker |
| Waxiness | less | 0 | more |
| Chewiness | less | 0 | more |
| Flavour release time | slower | 0 | quicker |
| Flavour retention | shorter | 0 | longer |
| Flavour impact | less | 0 | more |
| Aftertaste | shorter | 0 | longer |
| Sourness | less | 0 | more |

5.1.4 Results and Conclusions

In table 1.9 the results of the sensory evaluation for the truffle application can be found. Only the results for sample F (fraction A) are described, since sample R is the reference and was zero on the line scale. Table 1.9 shows only the attribute results, which appeared to be different between the two evaluated samples. All the other data was left out.

TABLE 1.9
Results of the sensory evaluation of white
truffle filling with fraction B (sample F) regarding to
the reference (sample R)

| | | | | Number of |
|---|---|---|---|---|
| | Result | Average | Number of | panelists |
| Truffle | of | of the | panelists positive | specific |
| attribute | panel | panel | or negative | difference |
| Bleeding of | less | −2.2 | 12/12 = less | 9/12 = −2.0, |
| inclusions | | | bleeding of the | clear |
| | | | inclusion | difference |

It showed that using Raspberry fraction B resulted in a visual sensation of the distinctive inclusion pieces, namely less bleeding compared to the unsieved Raspberry material.

It can be concluded from this data that with the unsieved Raspberry material it was less possible to identify a pink inclusion in a white truffle filling, since there was more bleeding of the inclusion into the substrate. The white truffle filling was not identifiable anymore as being a white truffle filling. Using Raspberry from fraction A, it showed less bleeding and therefore a more identifiable substrate with a distinctive inclusion.

Appendix

TABLE 1.10
Particle size distribution of ground, unsieved
material from experiment 1
Experiment 1

| Average | | Weight |
|---|---|---|
| Diameter | Percentage | Diameter |
| (microns) | (%) | (microns) |
| 4050 | 3.2 | 129.6 |
| 2855 | 25.7 | 733.7 |
| 2180 | 8.1 | 176.6 |
| 1850 | 11.7 | 216.5 |
| 1550 | 7.8 | 120.9 |
| 1290 | 6.4 | 82.6 |
| 1090 | 7.3 | 79.6 |
| 925 | 2.0 | 18.5 |
| 675 | 27.2 | 183.6 |

TABLE 1.11
Particle size distribution of fraction A from
experiment 1

| Average | | Weight |
|---|---|---|
| Diameter | Percentage | Diameter |
| (microns) | (%) | (microns) |
| 4050 | 3.1 | 125.6 |
| 2855 | 74.7 | 2132.7 |
| 2180 | 18.4 | 401.1 |
| 1850 | 3.3 | 61.1 |
| 1550 | 0.2 | 3.1 |

TABLE 1.12
Particle size distribution of fraction B from
experiment 1

| Average | | Weight |
|---|---|---|
| Diameter | Percentage | Diameter |
| (microns) | (%) | (microns) |
| 2855 | 0 | — |
| 2180 | 13.3 | 289.9 |
| 1850 | 33.1 | 612.4 |
| 1550 | 22.7 | 351.9 |
| 1290 | 16 | 206.4 |
| 1090 | 11 | 119.9 |
| 925 | 2.3 | 21.3 |
| 675 | 1.6 | 10.8 |

TABLE 1.13
Particle size distribution of fraction C from
experiment 1

| Average | | Weight |
|---|---|---|
| Diameter | Percentage | Diameter |
| (microns) | (%) | (microns) |
| 1290 | 0.2 | 2.6 |
| 1090 | 4.2 | 45.8 |
| 925 | 5.4 | 50.0 |
| 725 | 24.9 | 180.5 |
| 512.5 | 23.1 | 118.4 |
| 362.5 | 37.9 | 137.4 |
| 275 | 4.3 | 11.8 |

TABLE 1.14
Mean weight diameter of each fraction from
experiment 1

| | Mean weight | | |
|---|---|---|---|
| | diameter | % within ± | % within ± |
| Fraction | (microns) | 0.4 of MWD | 0.3 of MWD |
| Unsieved fraction | 1741.6 | 37.9 | 26.6 |
| Fraction A | 2723.6 | 97.6 | 95.8 |
| Fraction B | 1612.6 | 94.1 | 83.2 |
| Fraction C | 546.5 | | |

TABLE 1.15
Particle size distribution of ground, unsieved
material from experiment 2
Experiment 2

| Average | | Weight |
|---|---|---|
| Diameter | Percentage | Diameter |
| (microns) | (%) | (microns) |
| 4050 | 0.8 | 32.4 |
| 2855 | 15.4 | 439.7 |
| 2180 | 14.6 | 318.3 |
| 1850 | 11.9 | 220.2 |
| 1550 | 11.7 | 181.4 |
| 1290 | 10.1 | 130.3 |
| 1090 | 9.5 | 103.6 |
| 925 | 3.3 | 30.5 |
| 675 | 22.5 | 151.9 |

TABLE 1.16
Particle size distribution of fraction A from
experiment 2

| Average | | Weight |
|---|---|---|
| Diameter | Percentage | Diameter |
| (microns) | (%) | (microns) |
| 4050 | 7.2 | 291.6 |
| 2855 | 70 | 1998.5 |
| 2180 | 21.3 | 464.3 |
| 1850 | 1 | 18.5 |
| 1550 | 0.2 | 3.1 |

TABLE 1.17
Particle size distribution of fraction B from
experiment 2

| Average | | Weight |
|---|---|---|
| Diameter | Percentage | Diameter |
| (microns) | (%) | (microns) |
| 2855 | 0 | — |
| 2180 | 21.5 | 468.7 |
| 1850 | 28.7 | 531 |
| 1550 | 23.3 | 361.2 |
| 1290 | 25.9 | 334.1 |
| 1090 | 0 | — |
| 925 | 0.4 | 3.7 |
| 675 | 0.3 | 2 |

TABLE 1.18
Mean weight diameter of each fraction from
experiment 2

| | Mean weight | | |
|---|---|---|---|
| | diameter | % within ± | % within ± |
| Fraction | (microns) | 0.4 of MWD | 0.3 of MWD |
| Unsieved fraction | 1608.3 | 55.9 | 44.0 |
| Fraction A | 2776 | 95.2 | 93.4 |
| Fraction B | 1700.7 | 99.6 | 90.9 |

1. Micronised fat continuous particles comprising fat and non fat ingredients, wherein the particles have a mean weight diameter (MWD) of 700 to 4000 microns, while the particles have a particle size distribution so that more than 75 wt % of the particles have a particle size that is inside the range (MWD+0.4×MWD) to (MWD−0.4×MWD).

2. Micronised fat continuous particles according to claim 1 wherein the particles have a MWD of 1000 to 3500 microns, preferably 1500 to 3000 microns.

3. Micronised particles according to claims 1 or 2 wherein the particles have a size distribution so that more than 75 wt % is inside the range (MDW+0.3×MDW) to (MDW−0.3×MDW).

4. Micronised particles according to claims 1 to 3 wherein the particles comprise 10 to 90 wt % of non fat ingredients, preferably 20 to 80 wt %, more preferably 25 to 60 wt %.

5. Micronised particles according to claims 1 to 4 wherein the non fat ingredients are at least one ingredient selected from the group consisting of sugars, carbohydrates, starches, modified starches and flavouring compounds.

6. Micronised particles according to claims 1 to 5 wherein the non fat ingredients are nutritionally active ingredients.

7. Micronised particles according to claims 1 to 6 wherein the fat is a fat that displays a melting point between −5° C. and 75° C., preferably between 10 and 50° C., most preferably between 15 and 45° C.

8. Micronised particles according to claim 7 wherein the fat is selected from a fat selected from the group consisting of: sunflower oil, palm oil, rape oil, cotton seed oil, soy bean oil, maize oil, shea oil, cocoa butter, or fractions thereof or in a hardened form or as fraction of the hardened oil or as partially hydrolysed oil rich in diglycerides or as mixtures thereof.

9. Micronised particles according to claim 7 wherein the fat is a nutrionally active fat, preferably selected from a CLA-glyceride or a fat that comprises PUFA fatty acid in high amounts such as fish oil, fish oil concentrates, fungal oils.

10. Micronised particles according to claims 1 to 9 wherein the flavour is selected from the group consisting of butter flavour, cinnamon flavour, fruit flavour, cheese flavour.

11. Micronised particles according to claims 1 to 10 wherein the particles comprise less than 2 wt % of water.

12. Food products comprising a fat phase wherein more than 30 wt % of the micronised particles according to claims 1 to 11 are present.

13. Food products according to claim 12 wherein the food product is selected from the group consisting of ice cream, baked goods, coatings, fillings, toppings, soups, sauces, dry mixes, spreads.

14. Process for the preparation of micronised fat continuous particles with the composition according to claims 1 to 11 wherein:
a fat melt is made
non fat ingredients are slurried in the molten fat
the slurry is cooled, preferably on a flaking drum cooler
flakes of a fat continuous slurry are collected from the drum flaker
which flakes optionally are reduced in size, preferably by a breaker bar system
whereupon either the flakes or the size reduced flakes are subjected to a cryomilling by cooling them with a cryocoolant, such as liquid nitrogen or solid carbon dioxide and reducing them in size while cold, in particular while having a temperature of −85 to 10° C.

15. Process according to claim 14 wherein the particles are milled in the cryomiller to a particle size of more than 20 microns and in particular to particles with the size and size distribution, mentioned in claim 1.

16. Use of particles with the composition according to claim 1 wherein the particles are applied in food products to:
improve the bioavailability of the nutrional ingredients present in the particles and/or
to improve the stability of the nutrional ingredients present in the food products and/or
to improve oral melt, hardness or texture of food products and/or
to improve the homogeneity of the active ingredient in the food products and/or
to improve the ease of dosing of minor components in food products.
